(19) United States
(12) Patent Application Publication
(10) Pub. No.: US 2009/0290608 A1
(43) Pub. Date: Nov. 26, 2009

(54) Photochemistry Laser Diode Assembly And Photochemistry Sheet Having The Same

(76) Inventor: Kyung Mok Kim, Wonju-si (KR)

Correspondence Address: Hyun Jong Park;Park & Associates Intellectual Property Law LLC, Suite 106, 265 Bic Drive, Milford, CT, 06461, US

(21) Appl. No.: 12/536,280

(22) Filed: Aug. 5, 2009

(30) Foreign Application Priority Data
Feb. 6, 2007 (KR) 10-2007-0012254
Feb. 20, 2007 (KR) 10-2007-0017146
Apr. 11, 2007 (KR) 10-2007-0035458
May 4, 2007 (KR) 10-2007-0043580
Feb. 11, 2008 (KR) PCT/KR2008/000783

(51) Int. Cl. H01S 3/04; H01S 3/00

(52) U.S. Cl. 372/36; 372/38.02

(57) ABSTRACT

A laser diode (LD) assembly for medical therapy and a medical therapy sheet having the same, which are capable of facilitating the assembly and maintenance of a laser diode (LD) which can emit laser beams or beams having a wavelength which is the same as or similar to that of the laser beams, effectively dissipating the heat generated from the laser diode, and recycling the heat for medical therapy, and which has good waterproofness. The medical therapy sheet includes a sheet body having installation holes, and laser diode assemblies detachably installed in the installation holes of the sheet body. Each laser diode assembly includes a laser diode, a first housing having an accommodation space in which the laser diode is received, a driving circuit board connected with the laser diode in order to drive the laser diode, and a second housing detachably coupled to the first housing.

### REFERENCE TO RELATED APPLICATIONS

This a continuation of pending International Patent Application PCT/KR2008/000783 filed on Feb. 11, 2008, which designates the United States and claims priority of Korean Patent Applications No. 10-2007-0012254 (filed Feb. 6, 2007), 10-2007-0017146 (filed Feb. 20, 2007), 10-2007-0035458 (filed Apr. 11, 2007), and 10-2007-0043580 (filed May 4, 2007), the entire contents of which are incorporated herein by reference.

### FIELD OF THE INVENTION

The present invention relates to a laser diode assembly for medical therapy and a medical therapy sheet having the same, and more particularly to a laser diode assembly for medical therapy and a medical treatment sheet that allows a laser diode (LD), which can emit laser beams or light beams having a wavelength which is the same as or similar to that of the laser beams, to be easily assembled and maintained, that can effectively dissipate the heat generated from the laser diode outside the laser diode assembly, that can recycle the heat for medical therapy, and that have good waterproofness and light irradiation efficiency.

### BACKGROUND OF THE INVENTION

As generally known in the art, the laser diode (LD) is an element using the photoelectric phenomenon of a compound semiconductor, and the application range thereof is widely expanding so as to reach medical fields, besides conventional application fields such as optical communication, office automation (OA), audiovisual (AV), and measurement fields.

Photochemical reactions are generally observed in carbon dioxide assimilation in plants. However, it is also known that adenosine triphosphate (ATP) is produced by the photochemical reaction, and that cells become active when light irradiates a living body.

That is, it is also known that medical therapy, such as pain relief, rapid regeneration of the diseased part, and removal of the cause of disease can be achieved by irradiating a living body with laser beams or light beams having a wavelength which is the same as or similar to that of the laser beams at low energy, at which the cells of a living body are not damaged, to activate the physiological functions of the living body. It is further known that different medical therapy effects can be achieved according to the wavelengths of the used beams.

Recently, low level laser therapy (LLLT) and light emitting diode therapy (LEDT) are generally known as therapies using laser beams or light beams having a wavelength which is the same as or similar to that of the laser beams.

The laser beams used in the LLLT can be generated by a He—Ne laser, a semiconductor laser or a YAG laser. The semiconductor laser has an advantage over the others in the aspect of price, and thus a semiconductor laser using Ga—As having a wavelength of 904 nm, Ga—Al—As having a wavelength in the range from 780 to 820 or from 780 to 870 nm, or In—Ga—Al—P having a wavelength in the range from 630 to 685 nm is generally used.

Accordingly, various kinds of medical therapy mats or mattresses, which emit light beams, have recently emerged on commercial markets.

However, known medical therapy products that emit light beams have a problem in that it is difficult to install or combine laser diodes in or with a mat, a blanket, or a mattress, resulting in high manufacturing costs. Moreover, since it is difficult to disassemble the diodes and the mat, sheet or mattress from each other when performing replacement and repair of the diodes, the medical therapy products are not easy to maintain.

The known laser diode assembly has another problem in that it generates a lot of heat from the printed circuit board (PCB) thereof during the operation thereof, which leads to malfunctions and deteriorates the efficiency with which the irradiated laser beams are concentrated or diffused.

### SUMMARY OF THE INVENTION

The invention is provided to realize a medical therapy laser diode assembly and a medical therapy sheet that can allow laser diodes to be easily installed in or combined with a medical therapy mat, such as a mat, a blanket, and a mattress, and also allow the laser diodes to be easily separated from the medical therapy mat, resulting in increased ease of maintenance.

The invention is also provided to realize a medical therapy laser diode assembly and a medical therapy sheet that can easily dissipate heat generated from laser diodes outside the assembly and the sheet, and, moreover, can positively recycle the dissipated heat for the purpose of heating.

The invention is further provided to realize a medical therapy laser diode assembly and a medical therapy sheet that can easily dissipate heat and improve the efficiency of irradiation of laser beams.

In order to accomplish the object, there is provided a medical therapy laser diode assembly including a laser diode which generates laser beams, a first housing having an accommodation space in which the laser diode is received, a driving circuit board which is connected with the laser diode received in the first housing in order to drive the laser diode, and a second housing detachably coupled to the first housing, in which the first housing and the second housing have a first pressing face and a second pressing face, respectively, which are adjacent to each other and are spaced apart by a predetermined distance. In order to accomplish the object, there is further provided a medical therapy sheet including a sheet body having a plurality of installation holes and laser diode assemblies detachably installed in the installation holes, in which each laser diode assembly includes a laser diode which generates laser beams, a first housing having an accommodation space in which the laser diode is received, a driving circuit board which is connected with the laser diode received in the first housing in order to drive the laser diode, and a second housing detachably coupled to the first housing, in which the first housing and the second housing have a first pressing face and a second pressing face, respectively, which are adjacent to each other and are spaced apart by a predetermined distance, and in which the first and second pressing faces put pressure on the edge of the installation hole of the sheet body. In order to accomplish the object of the invention, there is still further provided a laser diode assembly including a laser diode having a light source and a penetration hole which allows laser beams from the light source to pass therethrough, a printed circuit board connected with the laser diode, a heat sinking member made of a heat conductive material and structured to surround the printed circuit board, and a lens installed to cover the penetration hole of the laser diode.

The features and advantages of the invention will be apparent from the following description with reference to the accompanying drawings. The terms used in the specification and claims of the invention may not be intended to refer exclusively to dictionary definitions, but may be intended to refer to meanings and concepts in accordance with the technical spirit of the invention on the ground that an inventor can act as his or her own lexicographer in order to explain his or her invention in the best way.

The medical therapy diode assembly and a medical therapy sheet are advantageous in that it is possible to allow a laser diode to be installed in or assembled with a sheet such as a mat, a blanket, and a mattress and to be separated from the sheet in a simple and easy way, which leads to increased ease of maintenance. Further, the medical therapy diode assembly and a medical therapy sheet are advantageous in that it is possible to effectively dissipate heat generated from the laser diode and to recycle the generated heat as hot air for heating. Still further, it is possible to improve the waterproofness, so that it is possible to prevent moisture or mist from intruding into the laser diode or a driving circuit board.

Moreover, it is possible to easily dissipate the heat and to improve the irradiation efficiency of the laser beam.

### BRIEF DESCRIPTION OF THE DRAWINGS

The above and other objects and advantages of the present invention will become readily apparent by reference to the following detailed description when considered in conjunction with the accompanying drawing wherein:

FIG. 1 is an exploded sectional view illustrating a laser diode assembly according to a first embodiment;

FIG. 2 is a sectional view illustrating the laser diode assembly according to the first embodiment;

FIG. 3 is a sectional view illustrating a medical therapy sheet according to the first embodiment;

FIG. 4 is an exploded sectional view illustrating a laser diode assembly according to a second embodiment;

FIG. 5 is a sectional view illustrating a medical therapy sheet according to the second embodiment;

FIG. 6 is an exploded perspective view illustrating a laser diode assembly according to a third embodiment;

FIG. 7 is a sectional view illustrating a medical therapy sheet according to the third embodiment;

FIG. 8 is a sectional view illustrating a laser diode assembly and a medical therapy sheet according to a fourth embodiment;

FIG. 9 is a sectional view illustrating a laser diode assembly and a medical therapy sheet according to a fifth embodiment;

FIG. 10 is a perspective view illustrating a method of manufacturing the laser diode assembly according to the fifth embodiment;

FIG. 11 is a sectional view illustrating a partial sectional view illustrating the medical therapy sheet according to the fifth embodiment;

FIG. 12 is an exemplary view illustrating a medical therapy mat as an application of the laser diode assembly and the medical therapy sheet according to the invention;

FIG. 13 is an exemplary view illustrating a medical therapy band as a further application of the laser diode assembly and the medical therapy sheet according to the invention;

FIG. 14 is an exemplary view illustrating an anti-alopecia apparatus as a still further application of the medical therapy diode assembly and the medical therapy sheet;

FIG. 15 is a perspective view illustrating a laser diode assembly according to a further embodiment of the invention;

FIG. 16 is an exploded perspective view illustrating the laser diode assembly of FIG. 15;

FIG. 17 is a sectional view illustrating the laser diode assembly of FIG. 15; and

FIG. 18 is a photograph showing the laser diode assembly of FIG. 15.

### DETAILED DESCRIPTION OF THE INVENTION

The features and advantages of the invention will be apparent from the following description.

Hereinafter, a laser diode assembly and a medical therapy sheet having the same according to the best mode of the invention will be described with reference to the accompanying drawings.

It should be noted that like elements and parts in the drawings are referenced by like reference numbers. Upon describing the invention, a description of functions and structures of the related arts will be omitted in order to avoid obscuring the spirit of the invention.

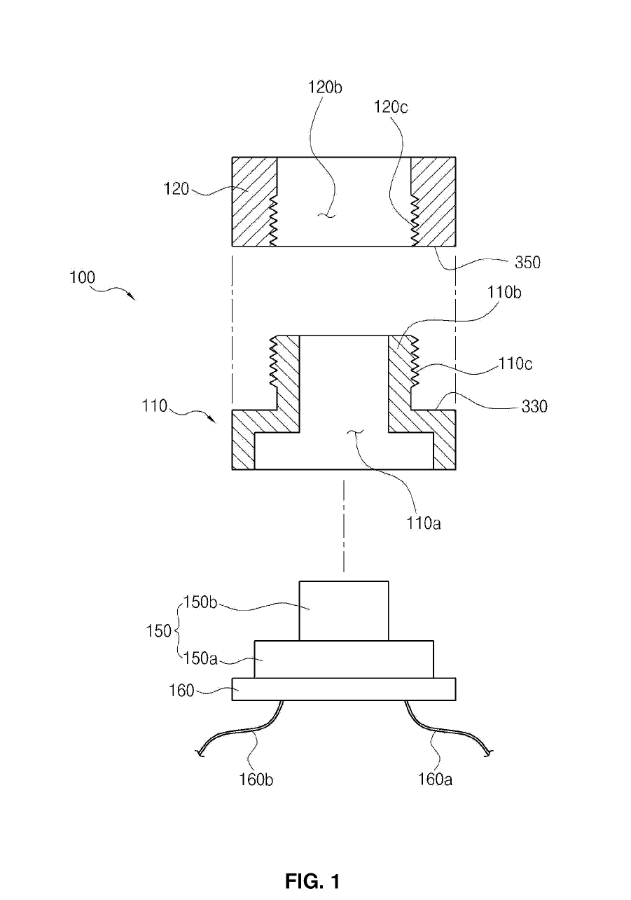

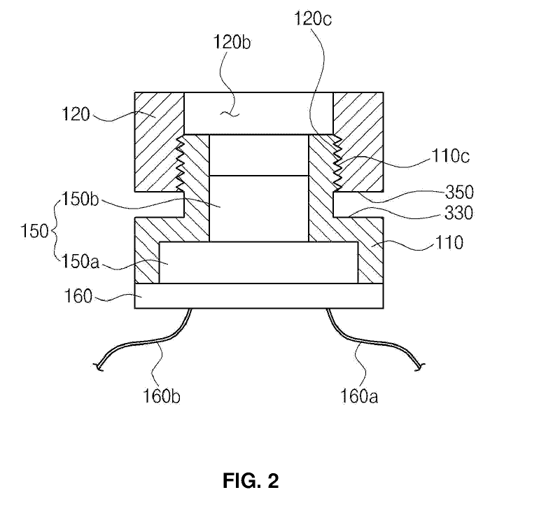

FIG. 1 and FIG. 2 show a medical therapy laser diode assembly according to a first embodiment.

As shown in FIGS. 1 and 2, the medical therapy laser diode assembly 100 includes a laser diode 150, a first housing 110, and a second housing 120.

The laser diode 150 can have a variety of structures, as long as they can generate laser beams having a wavelength in the range from 600 to 890 nm, which are suitable for various kinds of medical therapy. FIGS. 1 to 5 show examples of packages for the laser diode 105.

The laser diode 150 includes a stem 150a which has a light source (not shown) and a photodiode, and a cylindrical cover 150b which has a light penetration hole (not shown), which allows the light from the light source (not shown) to pass therethrough, so that the light can be directed outside the laser diode 150. The cylindrical cover 150b is provided to the upper end portion of the stem 150a. A lens (not shown), which allows the light from the light source to pass therethrough, is provided to an upper end portion of the light penetration hole of the cylindrical cover 150b. The first housing 110 has an accommodation space 110a, which receives the laser diode 150 therein, and a coupling portion 110b at an upper end portion thereof.

The second housing 120 has a coupling groove 120b, which engages with the coupling portion 110b of the first housing 110. According to the first embodiment, the coupling groove 120b is open at an upper end portion thereof and a lens (not shown), which can emit laser beams from the laser diode 150 in a wider variety of angles, can be provided in the upper end portion of the coupling groove 120b. The outer circumferential surface of the coupling portion 110b of the first housing 110 is provided with male threads 110c, and the inner circumferential surface of the coupling groove 120b is provided with female threads 120c that engage with the male threads 110. The first housing 110 and the second housing 120 are detachably coupled to each other in a manner such that the coupling portion 110b of the first housing 110 engages with the coupling groove 120b of the second housing 120 in a threaded manner using the male and female threads 110c and 120c. Accordingly, the laser diode is advantageous in that it can be easily assembled and disassembled.

A driving circuit board 160, which drives the laser diode 150 provided in the accommodation space 110a of the first housing 110, is connected with the laser diode 150, and one or more wires 160 and 160b are pulled out from the driving circuit board 160.

It is preferable that the first housing 110 and the second housing 120 be made of heat conductive material so that they can effectively dissipate heat, generated from the laser diode 150, outside. The heat conductive material may include aluminum, aluminum alloy, copper, copper alloy, silver, and silver alloy.

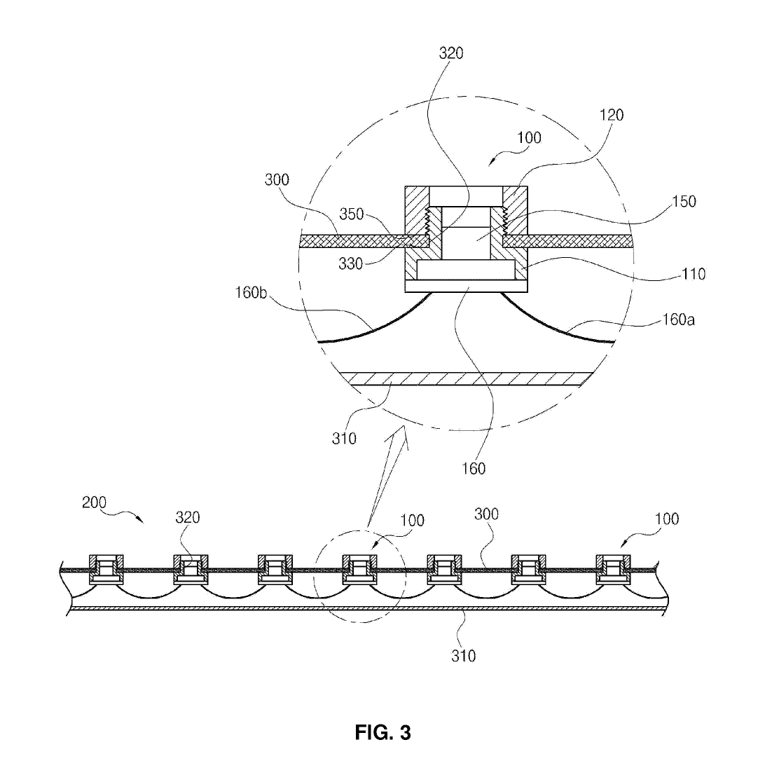

The first housing and the second housing 110 and 120 have a first pressing surface 330 and a second pressing surface 350, respectively, which are adjacent to each other but are spaced from each other by a predetermined distance. An edge portion of an installation hole 320 of a sheet body 300, which will be described below, is inserted into the gap between the first pressing surface 330 and the second pressing surface 350. FIG. 3 shows the medical therapy sheet 200 according to the first embodiment.

As shown in FIG. 3, the medical therapy sheet 200 according to the invention includes a sheet body 300, and a plurality of diode assemblies 100, which are detachably coupled to the sheet body 300.

The sheet body 300 may be made of a sheet, such as woven fabric, knitted goods, a blanket, a mattress, unwoven fabric, or urethane textiles, and has a plurality of installation holes 320 distributed over the entire area thereof. The laser diode assemblies 100 can be detachably installed in respective installation holes 320.

The coupling portion 110b of the first housing 110 of the laser diode assembly 100 is inserted into the installation hole 320 from the underside, and then the coupling portion 110b of the first housing 110 and the coupling groove 120b of the second housing 120 are detachably coupled in a threaded manner using the male and female threads 110c and 120c. Thanks to this coupling, the first and second pressing faces 330 and 350 of the first and second housing 110 and 120 put pressure on the ends of the installation holes 320, so that the laser diode assemblies are securely fixed in the sheet body 300.

That is, after the coupling portions 110b of the first housing 110 are inserted into the corresponding installation holes 320 in the sheet body 300, the coupling portions 110b of the first housing 110 and the coupling grooves 120b of the second housing 120 are coupled to another in a threaded manner using the male and female threads 110c and 120c. In this way, the laser diodes 150 can be securely installed in the sheet body 300 upon assembly. Further, when decoupling the first and second housing 110 and 120 from each other for replacement or repair of the laser diodes 150, the laser diodes 150 can be easily repaired or replaced by unscrewing the male and female threads 110c and 120c. Accordingly, it is possible to greatly improve the ease of maintenance of the laser diode assemblies 100 and the medical therapy sheet 200 according to the invention.

A lower cover 310 is provided on the underside surface of the first housing 110 to support the underside surface of the medical therapy sheet 200 of the invention.

On the other hand, the medical therapy sheet 200 including the laser diode assemblies 100 of the invention is advantageous in that it is possible to effectively dissipate heat generated from the laser diodes 150 outside the medical therapy sheet since the first housing 110 and/or the second housing 120 of the laser diode assembly 100 are/is made of thermally conductive material. Moreover, it is possible to recycle the heat dissipated from the first and second housings 110 and 120 as hot air or for heating.

In particular, the second housing 120, which directly contacts the body of a user, and/or the first housing 110 may be made of metal having a negative potential, such as aluminum, aluminum alloy, silver, silver alloy, copper, and copper alloy. It is widely known that the pain of the user is alleviated and the blood circulation of the user is increased when metal having a negative potential directly contacts the body of a user because the muscles and/or nerves of the user react with the negative potential.

Moreover, when the second housing 120 is made of aluminum alloy, the aluminum alloy contains 90% aluminum and 10% of one or more kinds of inorganic elements selected from the group consisting of Si, Fe, Cu, Mn, Mg, Zn, Ti, Ni, K, Ca, B, and V. The aluminum alloy is processed to have a negative potential, and thus it can be used as a skin contact capacitor electrode.

Further, when the second housing 120 is made of silver or a silver alloy, silver in the second housing 120 contacts the body of a user and thus gives certain remedial effects to the user's body.

On the other hand, it is known that when metal having a low negative potential contacts the user's body, the metal gives remedial effects, such as alleviation of pain or an increase in blood circulation, to the user as the metal induces a reaction between the muscles and/or nerves of the user (see Korean Patent Registration No. 10-0389703; page 508, 5^{th} Edition of Low Back Pain: Mechanism, Diagnosis and Treatment by James Cox; pages 73, 74, 99 and 100, Bioelectronics by Robert Baker).

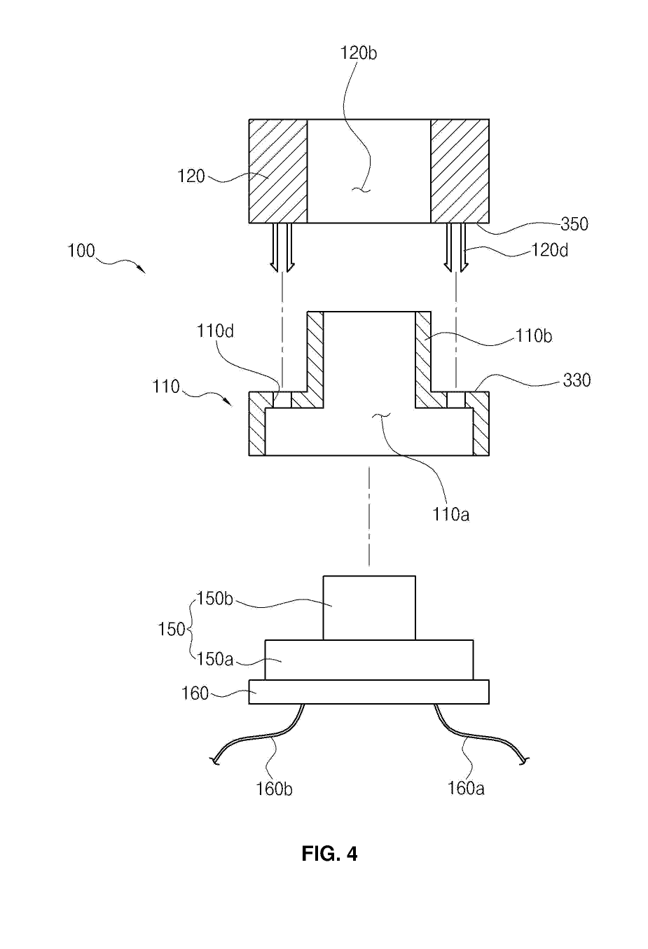

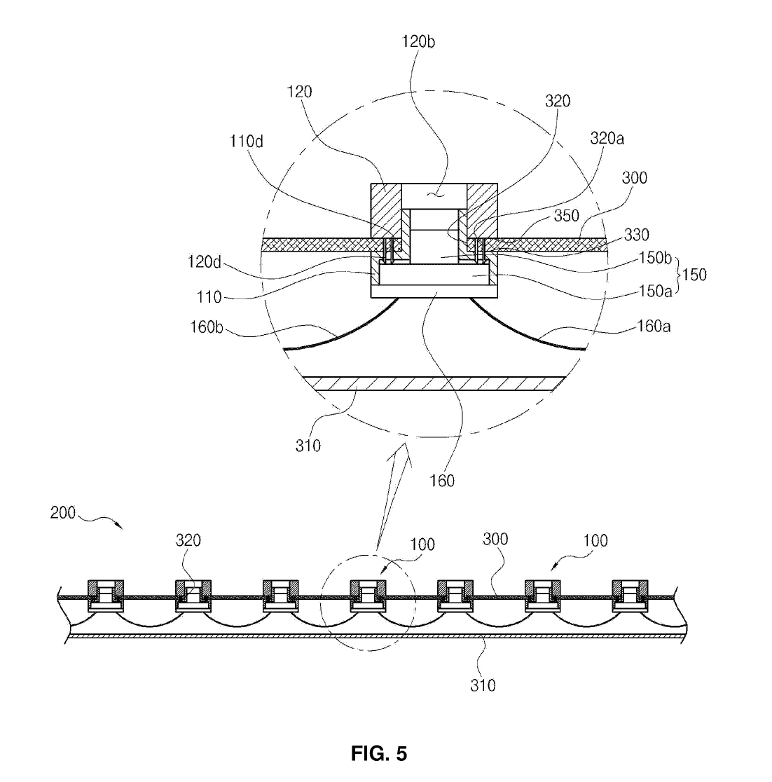

FIG. 4 shows a laser diode assembly 100 according to a second embodiment of the invention. The laser diode assembly 100 according to the second embodiment includes a first housing 100 and a second housing 200. The first housing 100 and the second housing 200 have a first pressing surface 330 and a second pressing surface 350, respectively, and further have hooks 11Od and hook eyes 12Od, respectively. As the hooks 11Od and the hook eyes 120d engage with each other, the first housing 110 and the second housing 120 are detachably coupled to each other. Corresponding to this structure, FIG. 5 shows a medical therapy sheet 200 according to a second embodiment of the invention. The medical therapy sheet 200 according to the second embodiment includes a sheet body 300 with a plurality of installation holes 320. In each of the installation holes, the laser diode assembly 100 shown in FIG. 4 is detachably installed. The sheet body 300 may have hook eyes 320 near the corresponding installation holes 320, so that the hook eyes 320a engage with the corresponding hooks 11Od.

Other structures and operations except for the above-described structures and operations are the same as or similar to the embodiment shown in FIGS. 1 to 3. Accordingly, detailed description thereof will be omitted.

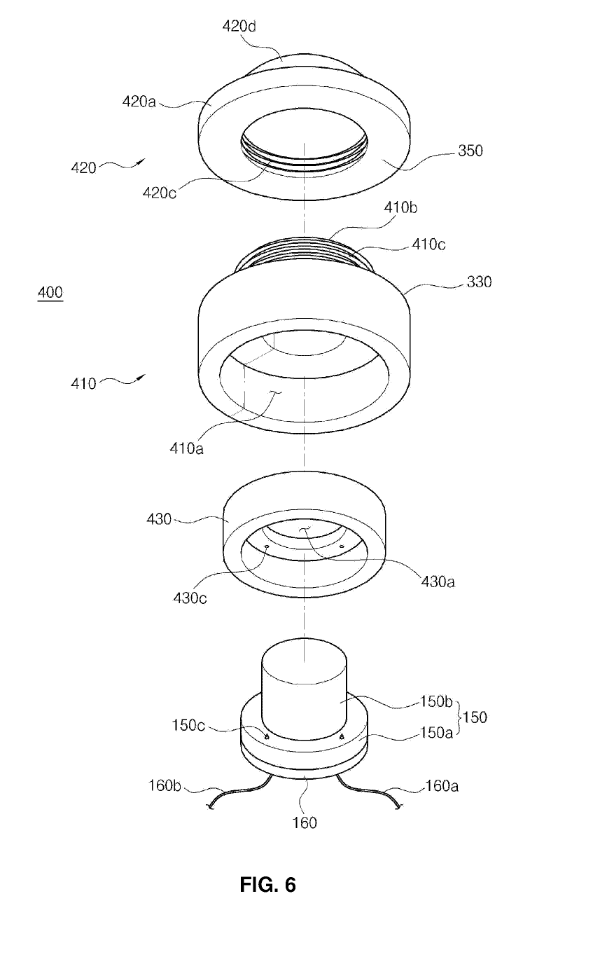

FIG. 6 shows a laser diode assembly 400 according to a third embodiment. As shown in FIG. 6, the laser diode assembly 400 according to the third embodiment includes a laser diode 150, a first housing 410, a second housing 420, and a heat sinking member 430.

The first housing 410 has an accommodation space 410a for receiving the laser diode 150 and the heat sinking member 430 therein. The first housing 410 is provided with a coupling portion 410b at an upper portion thereof, and male threads 410c are provided to the outer circumferential surface of the coupling portion 410b.

The second housing 420 may be provided with lenses 42Od at upper portions thereof in an integrated manner or an assembled manner. Frames 420a are provided around the outer circumferences of the corresponding lenses 420b. Inside the second housings 420, coupling grooves 420b, which are to engage with the coupling portions 410b of the first housing 410, are provided. The inner circumferential surface of each coupling groove 420b is provided with female threads 420c, which are to engage with the male threads 410c of each coupling portion 410b. The hemispherical lenses 42Od are made of transparent material so as to diffuse laser beams emitted from the laser diode in a large area.

The first housing 410 and the second housing 420 are detachably coupled to each other as the coupling portion 410b of the first housing 410 and the coupling groove 420b of the second housing 420 engage in a threaded manner using the male and female threads 410c and 420c. Accordingly, it is possible to easily assemble and disassemble the laser diode 150.

The first and second housings 410 and 420 have the first and second pressing faces 330 and 350, which are adjacent to each other and are spaced apart by a predetermined distance, respectively. An edge of the installation hole 320 of the sheet body 300, to be described later, is inserted into the gap between the first and second pressing faces 330 and 350.

A heat sinking member 430 is received in the accommodation space 410a in the first housing 410, and the laser diode 150 is received in the heat sinking member 430. A driving circuit board 160 is connected with the underside of the laser diode 150, and one or more wires 160a and 160b are pulled out from the driving circuit board 160. The heat sinking member 430 has an accommodation space 430a for receiving a portion of the laser diode 150 and the driving circuit board 160, and the laser diode 150 and the driving circuit board 160 are mounted inside the accommodation space 430a. A connection portion of the heat sinking member 430 and the laser diode 150 is provided with coupling protrusions and coupling grooves 150c and 430c, which correspond to each other, and thus the laser diode 150 and the heat sinking member 430 are stably mounted in the accommodation space 430a.

The heat sinking member 430 is made of heat conductive material, such as aluminum, aluminum alloy, copper, copper alloy, silver and silver alloy to effectively dissipate the heat generated from the laser diode 150 or the driving circuit board 160. The heat sinking member 430 may be provided with a plurality of heat sinking pins to increase the heat sinking efficiency thereof.

Further, the first housing 410 and the second housing 420 are also made of a heat conductive material, such as aluminum, aluminum alloy, copper, copper alloy, silver, or silver alloy, to dissipate the heat generated from the laser diode 150 or the driving circuit board 160 outside the laser diode assembly.

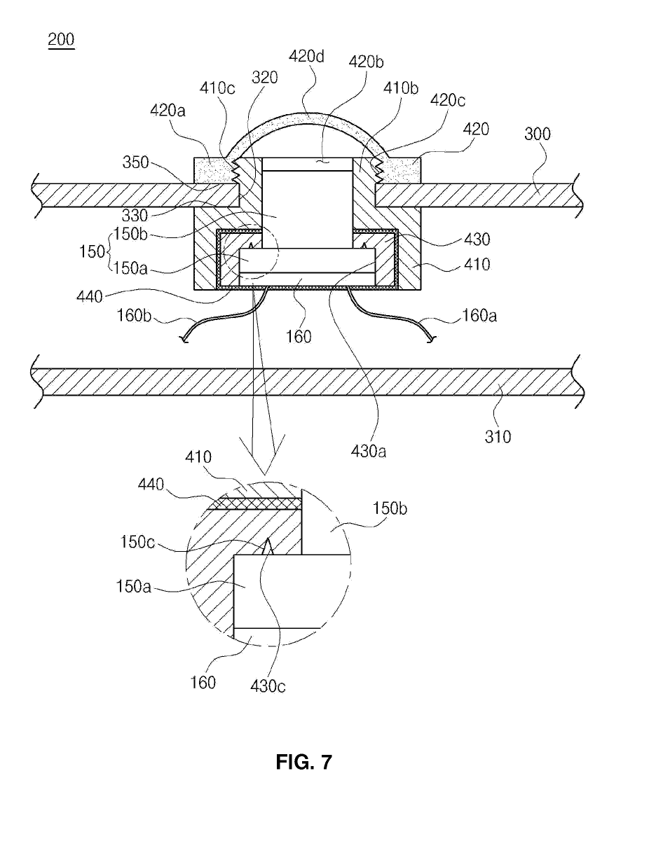

FIG. 7 shows a medical therapy sheet 200 according to a third embodiment of the invention. As shown in FIG. 7, the medical therapy sheet 200 according to the third embodiment is characterized in that the laser diode assemblies 400 shown in FIG. 6 are installed in a sheet body 300 having a plurality of installation holes 320. The laser diode assemblies 400 are securely fixed to the sheet body 300 in a manner such that the coupling portions 410b of the first housing 410 are inserted into the installation holes 320 in the sheet body 300, and then engage with the corresponding coupling grooves 420b in a threaded manner using the male and female threads 410c and 420c, and the first and second pressing faces 330 and 350 of the first and second housings 410 and 420 press against each other to put pressure on the edges of the installation holes 320 in the sheet body 300. On the other hand, according to the third embodiment, upper portions of the laser diodes 150 are sealed by the lenses 42Od of the second housing 420, so that it is possible to prevent moisture or mist from intruding into the laser diodes 150 or the driving circuit boards 160.

It is preferable that a sealing member be provided between the male threads 410c of the first housing 410 and the female threads 420c of the second housing 420 to improve the efficiency with which moisture is prevented from intruding into the laser diodes 150 and the driving circuit boards 160. The heat sinking member 430 is inserted into the accommodation space 410a in the first housing 410 from the underside, and is accommodated therein. Each laser diode 150 is inserted into the accommodation space 430a in the heat sinking member 430 from the underside and is accommodated therein. The lower portion of each laser diode 150 is connected to the driving circuit board 160, and one or more wires 160a and 160b is pulled out from the driving circuit board 160.

Since the driving circuit board 160 faces and is exposed to a lower cover 310 through the underside of the sheet body 300, the underside of the driving circuit board 160 may be coated with a sealing layer 440, such as epoxy. The sealing layer 440 prevents moisture and mist from intruding into the driving circuit board 160. The sealing layer 40 is coated in the gap between the heat sinking member 430 and the laser diode 150, and between the heat sinking member 430 and the driving circuit board 160 to enhance sealing efficiency.

That is, the medical therapy sheet 200 according to the third embodiment can effectively dissipate the heat generated from the laser diode 150 and the driving circuit board 160 outside the medical therapy sheet 200 through the heat conductive member 430. Further, the medical therapy sheet 200 can prevent moisture from intruding into the laser diode 150 and the driving circuit board 160 from the upper side by the lenses 42Od of the second housing 420 and from the underside, thanks to the sealing layer 440. That is, the medical therapy sheet 200 according to the third embodiment is advantageous in that it realizes greatly improved waterproofness of the laser diode 150 and the driving circuit board 160.

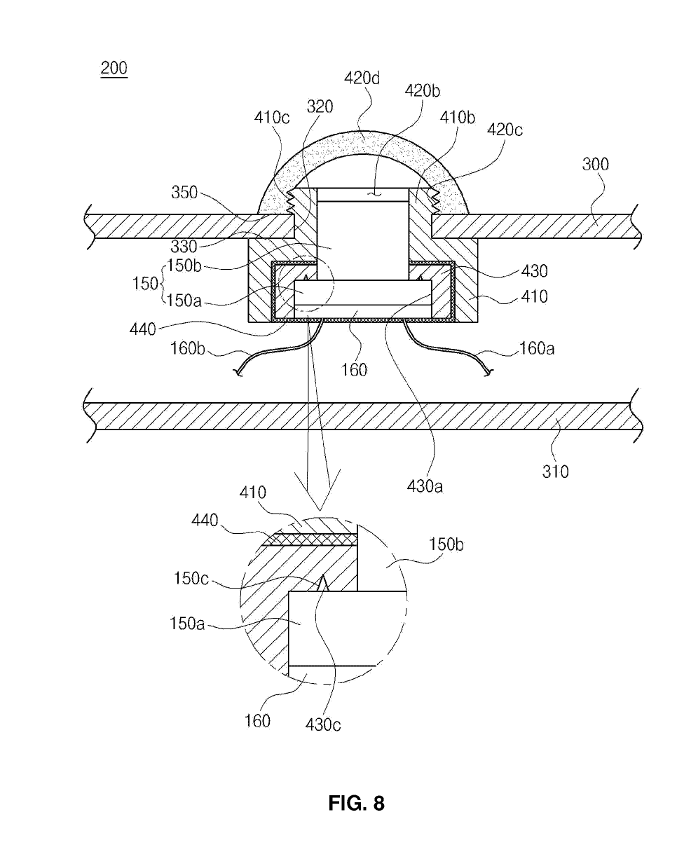

FIG. 8 shows a laser diode assembly 400 and a medical therapy sheet according to a fourth embodiment of the invention. The second housing 420 according to the second embodiment does not have frames 420a around the lenses 42Od. Further, the width of the first housing 410 and the width of the second housing 420 are the same as each other. Accordingly, it is possible to realize a more compact size laser diode assembly 400 with the fourth embodiment, and the fourth embodiment is advantageous in that it is possible to more simply assemble the laser diode assemblies 400 with the sheet body 300.

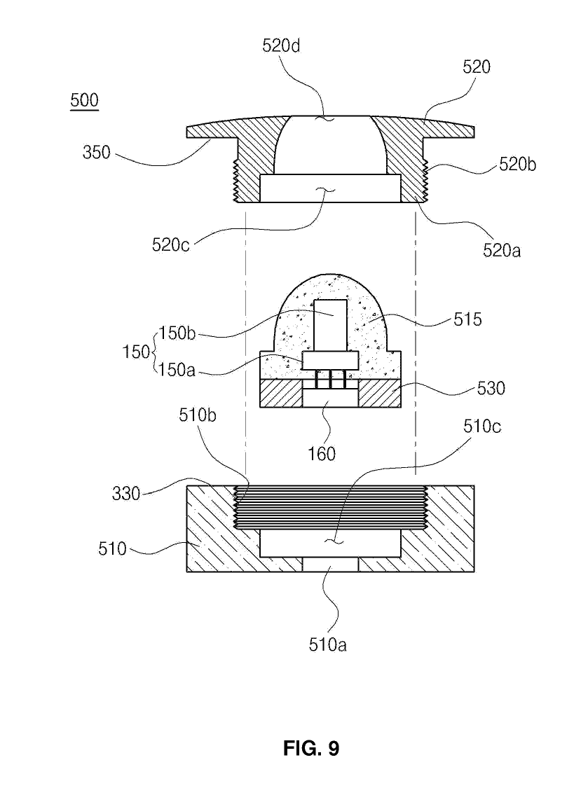

FIG. 9 shows a medical therapy laser diode assembly 500 according to a fifth embodiment of the invention.

As shown in FIG. 9, the medical therapy laser diode assembly 500 according to the fifth embodiment includes a laser diode 150, a first housing 510, a second housing 520, and a heat sinking member 530.

The first housing 510 has an accommodation space 510c for receiving the laser diode 150 and the heat sinking member 530 therein. The inner surface of the accommodation space 510c is provided with female threads 510b, and a penetration hole 510a is provided in the underside of the accommodation space 510c.

The second housing 520 has an accommodation space 520c for receiving the laser diode 150 therein. A coupling portion 520a is formed on an outer portion of the accommodation space 520c and the outer surface of the outer portion of the coupling portion 520a is provided with male threads 520b. A penetration hole 52Od is formed in the upper portion of the accommodation space 520c. The first housing 510 and the second housing 520 are coupled to each other in a threaded manner using the female threads 510b and the male threads 520b, and thus the accommodation spaces 510c and 520c are adjacent to each other. In these accommodation spaces 510c and 520c, the laser diode 150, the driving circuit board 160, and the heat sinking member 530 are received.

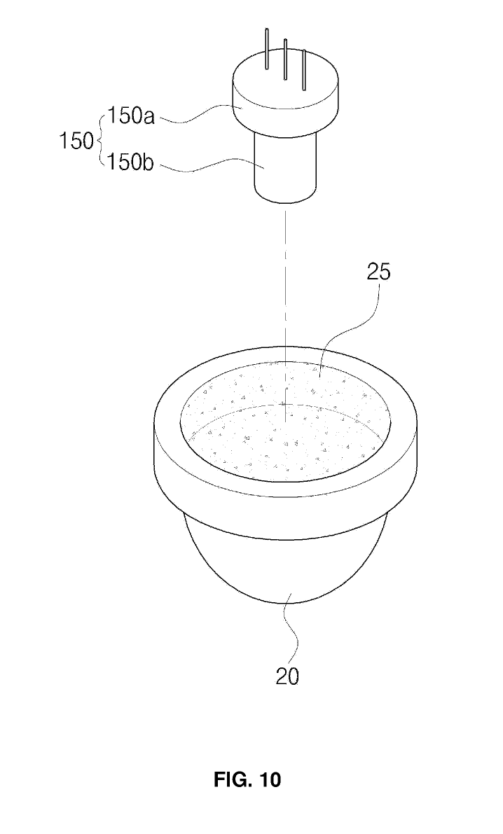

The laser diode 150 includes a lens 515, which is integrally formed at the outer side thereof. As shown in FIG. 10, the laser diode 150 and the lens 515 are integrally formed in a manner such that transparent or translucent melted synthetic resin 25 is injected into a molding cast 20 having a predetermined figure, the laser diode 150 is dipped into the melted synthetic resin 25, the melted synthetic resin 25 is cured for a predetermined period, and the molding cast 20 is separated from the cured synthetic resin 25, so that the lens 515 and the laser diode 150 are integrally formed.

An upper portion of the lens 515 is exposed through the penetration hole 52Od in the second housing 520, and thus laser beams emitted from the laser diode 150 diffuse in a variety of angles. That is, orientation angles can be diversely changed.

The first housing 510 and the second housing 520 are detachably coupled to each other in a threaded manner using the male and female threads 510c and 520c, so that it is possible to easily assemble and disassemble the laser diode 150.

The first housing 510 and the second housing 520 have a first pressing face 330 and a second pressing face 350, respectively, which are adjacent to each other and are spaced apart from each other by a predetermined distance. An edge portion of the installation hole 320 of the sheet body 300 is inserted into the gap between the first pressing face 330 and the second pressing face 350.

The heat sinking member 530 received in the accommodation space 510a of the first housing 510 is installed to surround the driving circuit board 160. The driving circuit board 160 is connected with the laser diode 150, and one or more wires 160a and 160b are pulled out from the driving circuit board 160.

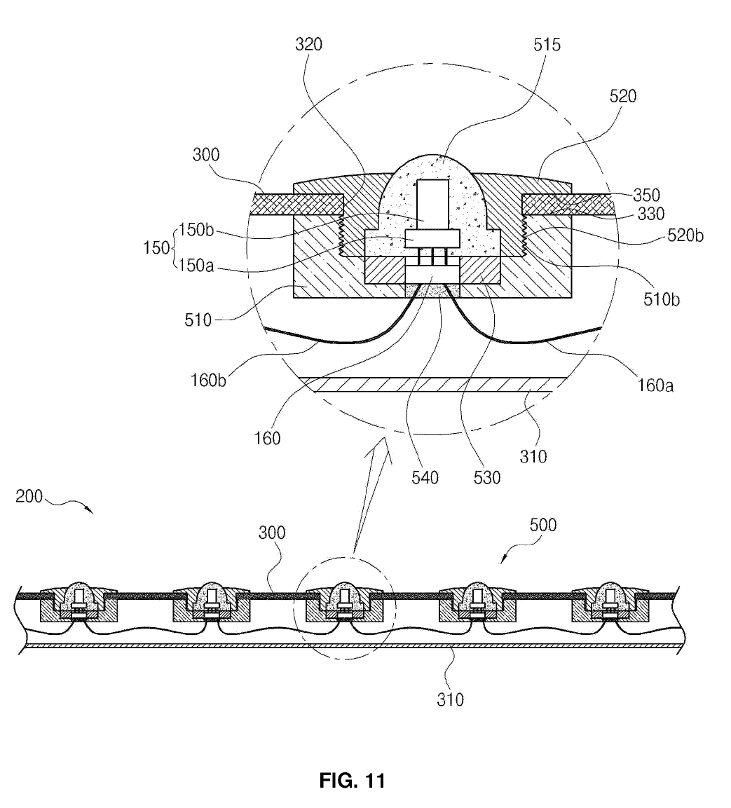

The heat sinking member 530 is made of heat conductive material, such as aluminum, aluminum alloy, copper, copper alloy, silver, and silver alloy, to dissipate the heat generated from the laser diode 150 or the driving circuit board 160, and is provided with a plurality of heat sinking pins to improve heat sinking efficiency. The first housing 510 and the second housing 520 may be made of heat conductive material, such as aluminum, aluminum alloy, copper, copper alloy, silver, and silver alloy to dissipate the heat generated from the laser diode 150 or the driving circuit board 160. FIG. 11 shows a medical therapy sheet 200 according to a fifth embodiment of the invention.

As shown in FIG. 11, the medical therapy sheet 200 according to the fifth embodiment is characterized in that the laser diodes 500 shown in FIG. 9 are installed in a sheet body 300 having a plurality of installation holes 320.

Coupling portions 520b of the second housings 520 are inserted into the installation holes 320 in the sheet body 300, the first housings 510 are coupled to coupling portions 520b of the second housings 520 in a threaded manner using the male and female threads 520b and 510b, and the first and second pressing faces 330 and 350 of the first and second housings 510 and 520 put pressure on the edges of the installation holes 320 in the sheet body 300, so that the laser diode assemblies 500 are securely fixed to the sheet body 300. According to the fifth embodiment, the lenses 515 are structured to surround the laser diodes 150, so that it is possible to prevent moisture and mist from intruding into the laser diode 150 and the driving circuit board 160 from the upper side. Since the underside of the driving circuit board 160 is exposed to the lower cover 310 of the sheet body 300, the lower surface of the driving circuit board 160 is coated with a sealing layer 540, such as epoxy. Accordingly, it is possible to prevent moisture or mist from entering into the laser diode 150 and the driving circuit board 160 from the underside. The sealing layer 540 is coated in the gap between the heat sinking member 530 and the laser diode 150 and between the heat sinking member 530 and the driving circuit board 160 to enhance the sealing efficiency. The medical therapy sheet 200 according to the fifth embodiment is advantageous in that it is possible to effectively dissipate the heat generated from the laser diode 150 and the driving circuit board 160 through the heat sinking member 530 outside the medical therapy sheet 200, and it is possible to greatly improve the waterproofness of the laser diode and the driving circuit board 160 by preventing moisture from intruding into the laser diode 150 and the driving circuit board 160 from the upper side using the laser 515, which surrounds the outer side of the laser diode 510, and preventing moisture from intruding into the laser diode 150 and the driving circuit board 160 from the underside using the sealing layer 54.

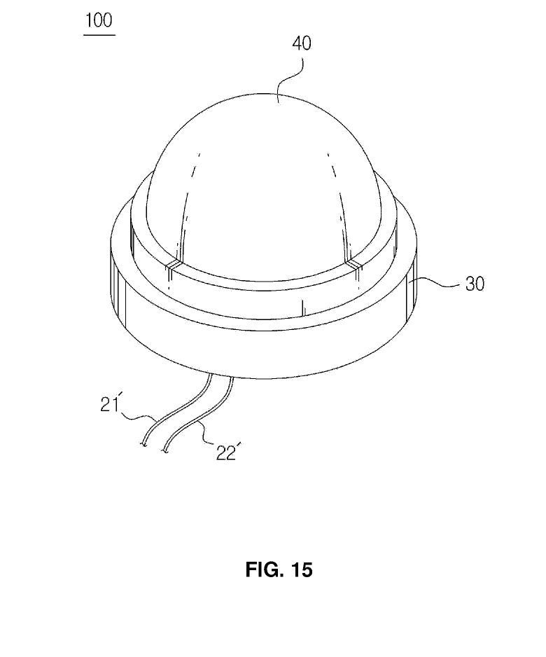

The laser diode assemblies 100, 400, and 500 according to the above-mentioned embodiments and the medical therapy sheet 200 can be used for scalp treatment or for arthritis treatment, as shown in FIG. 14. In FIG. 14, unexplained reference numerals 11 and 12 denote a low frequency generator and a hot wire, respectively.

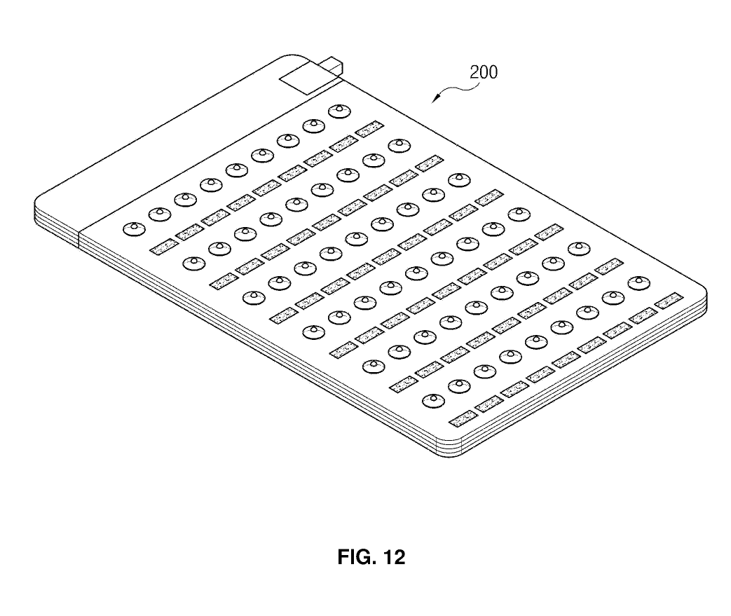

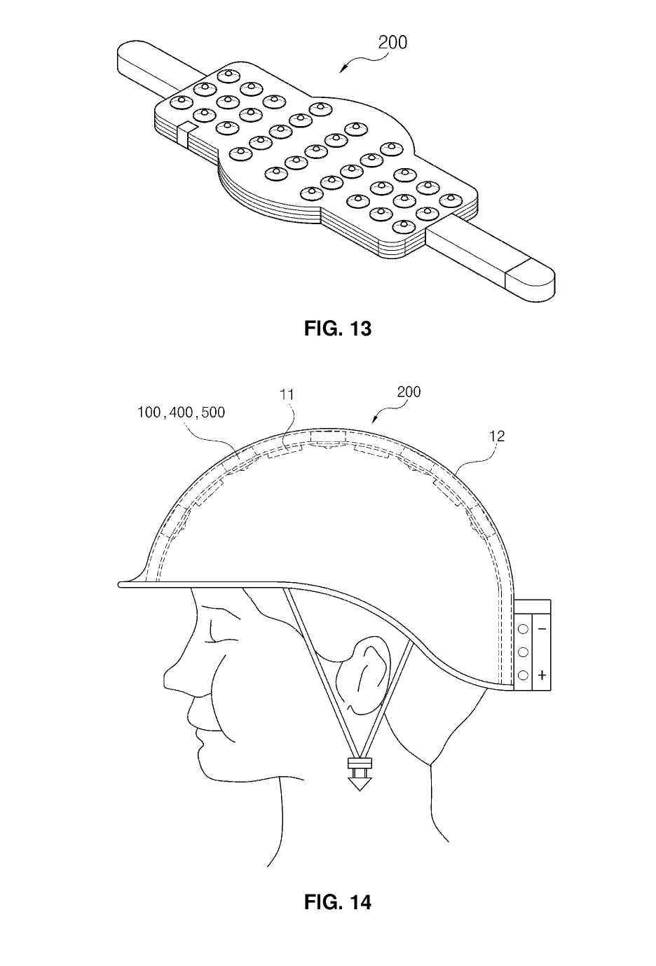

Besides scalp treatment and arthritis treatment, the laser diode assemblies 100, 400, and 500 and the medical therapy sheet 200 can be realized in a variety of forms and structures, such as a medical therapy mat (see FIG. 12), a medical therapy band (see FIG. 13), and a medical therapy mask.

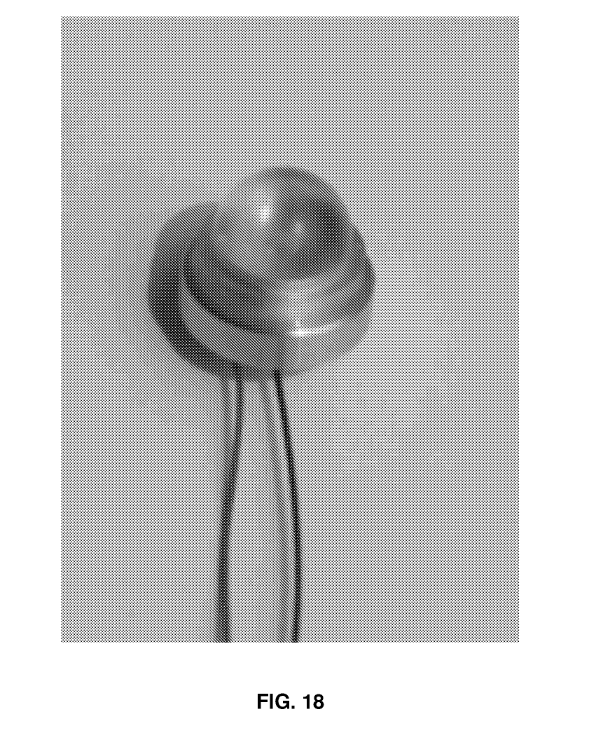

A laser diode assembly according to a further embodiment of the invention will be described with reference to FIGS. 15 and 18.

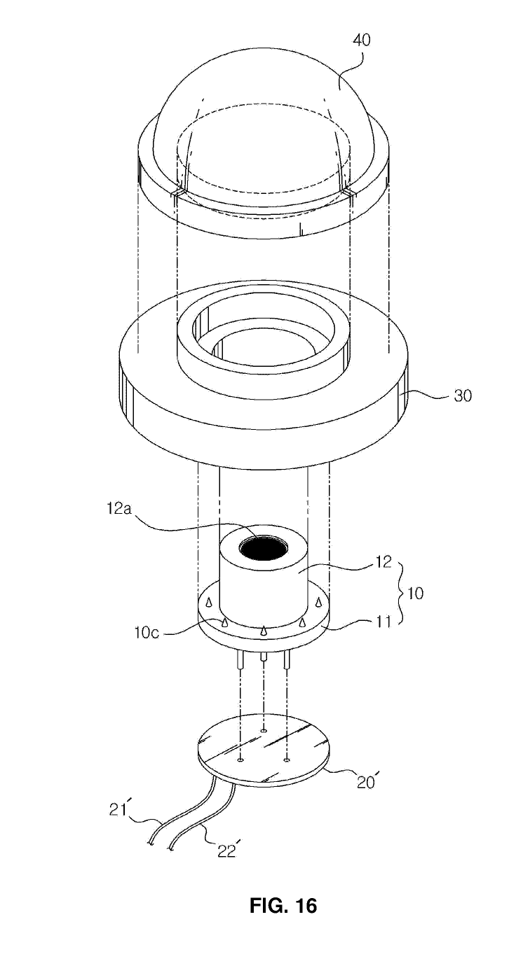

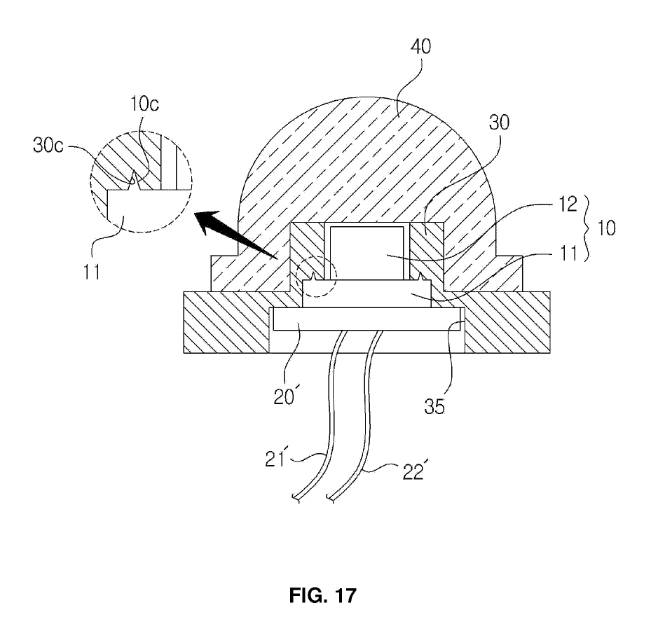

FIG. 15 is a perspective view illustrating a laser diode assembly according to the further embodiment of the invention, FIG. 16 is an exploded perspective view illustrating the laser diode assembly of FIG. 15, and FIG. 17 is a sectional view illustrating the laser diode assembly of FIG. 15. FIG. 18 is a photograph showing the laser diode assembly of FIG. 15.

As shown in FIGS. 15 to 18, the laser diode assembly 100 of the invention includes a laser diode 10, a printed circuit board 20′ electrically connected with the laser diode 10, a heat sinking member 30 surrounding the printed circuit board 20′, and a lens 40 provided at an upper portion of the laser diode 10.

The laser diode 10 may be one of a variety of types of laser diodes, which can emit laser beams having wavelengths suitable for medical treatment, in addition to optical transmission, office automation (OA), audiovisual (AV), and measurement fields.

As shown in FIG. 16, the laser diode 10 includes a light source (not shown) inside it, a stem 11 provided with a photodiode, and a cylindrical cover 12 with a penetration hole 12a which is provided at an upper portion of the stem 11 and allows the laser beams generated from the light source (not shown) to pass therethrough. The printed circuit board 20′ is electrically connected with the laser diode 10, and one or more wires 21′ and 22′ extend from the printed circuit board 20′.

The heat sinking member 30 has an accommodation space inside it, and the printed circuit board 20′ and/or the laser diode 10 are received in the accommodation space. The heat sinking member 30 is made of heat conductive material, such as aluminum, aluminum alloy, copper, copper alloy, silver and silver alloy to effectively expel the heat generated from the printed circuit board 20′ and/or the laser diode 10 during the operation of the laser diode 10. The heat sinking member 30 may be further provided with a plurality of heat sinking pins to improve heat sinking efficiency.

At the contact portion of the heat sinking member 30 and the laser diode 10, a coupling groove 30c and a coupling protrusion 10c are provided to correspond to each other so that the laser diode 10 can be securely received in the accommodation space of the heat sinking member 30.

The laser diode 10 includes a lens 40 in the circumferential surface thereof, and the lens 40 may be a convex lens (condensing lens), which collects light, a concave lens (a diverging lens), which diverges light, a combination lens, which is a combination of a concave lens and a convex lens, a spherical lens, or a non-spherical lens.

The lens 40 may be made of one or more materials of glass containing SiO₂, transparent resin, and epoxy resin. The lens 40 is structured to cover an end of the laser diode 10 with the penetration hole 12a, so that it is possible to effectively prevent moisture or mist from intruding into the laser diode 10 and the printed circuit board 20′ from the upper side.

The underside of the printed circuit board 20′ is coated with a sealing material 35, such as epoxy, at a portion at which the accommodation space of the heat sinking member 30 is provided, so that it is possible to prevent moisture or mist from intruding into the laser diode 10 and the printed circuit board 20′ from the underside thereof. The laser diode assembly 100 of the invention can effectively dissipate the heat generated from the laser diode 10 and the printed circuit board 20′ thanks to the heat sinking member 30 outside, and can effectively emit laser beams of the laser diode 10 thanks to the lens 40. The lens surrounds the upper end of the laser diode 10, and the gap between the printed circuit board 20′ and the laser diode 10 is filled with a sealing member 35, so that it is possible to prevent moisture or various foreign matter from intruding into the laser diode 10 and the printed circuit board 20′.

The invention is not limited to the above described embodiments and the accompanying drawings, and it will be apparent to those having ordinary skill in the art that a number of changes, modifications, or alterations to the invention as described herein may be made, none of which depart from the spirit of the present invention. All such changes, modifications and alterations should therefore be seen as falling within the scope of the present invention.

What is claimed is:

1. A medical therapy laser diode assembly, comprising:
a laser diode which generates laser beams;
a first housing having an accommodation space, in which the laser diode is to be received, inside thereof;
a driving circuit board which is connected with the laser diode received in the first housing in order to drive the laser diode; and
a second housing detachably coupled to the first housing,
wherein the first housing and the second housing have a first pressing face and a second pressing face, respectively, which are adjacent to each other and are spaced apart by a predetermined distance.

2. The laser diode assembly according to claim 1, wherein the first housing and the second housing have a coupling portion and a coupling groove, respectively, which are to engage with each other, and the coupling portion and the coupling groove are provided with screw threads.

3. The medical therapy laser diode assembly according to claim 1, wherein the first pressing face and the second pressing face of the first housing and the second housing have a hook and a hook eye, respectively, which are disposed to correspond to each other.

4. The medical therapy laser diode assembly according to claim 1, further comprising a heat sinking member which receives part of the laser diode and the driving circuit board,
wherein the heat sinking member is inserted into the accommodation space in the first housing, a connection portion of the first and second housings is provided with screw threads, an upper portion of the second housing is further provided with a lens, and a contact portion between the heat sinking member and the laser diode is provided with a coupling protrusion and a coupling groove that correspond to each other.

5. The medical therapy laser diode assembly according to claim 1, further comprising:
a lens which surrounds an outer surface of the laser diode; and
a heat sinking member which surrounds the driving circuit board,
wherein the heat sinking member is received in the accommodation space of the first housing, and a connection portion of the first and second housings is provided with screw threads.

6. A medical therapy sheet, comprising:
a sheet body having a plurality of installation holes; and
laser diode assemblies detachably installed in the installation holes,
wherein each of the laser diode assemblies includes:
a laser diode which generates laser beams;
a first housing having an accommodation space in which the laser diode is received;
a driving circuit board which is connected with the laser diode received in the first housing and which drives the laser diode; and
a second housing detachably coupled to the first housing,
wherein the first housing and the second housing have a first pressing face and a second pressing face, respectively, which are adjacent to each other and are spaced apart by a predetermined distance, and wherein the first and second pressing faces put pressure on an edge of the installation hole of the sheet body.

7. The medical therapy sheet according to claim 6, wherein the first housing and the second housing are provided with screw threads at a connection portion thereof.

8. The medical therapy sheet according to claim 6, wherein the first and second pressing faces of the first and second housings are provided with a hook and a hook eye, respectively, to correspond to each other.

9. The medical therapy sheet according to claim 6, further comprising:
a heat sinking member which receives part of the laser diode and the driving circuit board therein,
wherein the heat sinking member is received in an accommodation space of the first housing, each of the first and second housings are provided with screw threads at a connection portion therebetween, the second housing is further provided with a lens at an upper portion thereof, the first housing and the second housing are provided with a hook and a hook eye, respectively, to correspond to each other at a portion at which the heat sinking member and the laser diode contact each other, a sealing material is provided between the screw threads of the first housing and the screw threads of the second housing, and a sealing layer is applied on the underside of the driving circuit board.

10. The medical therapy laser diode assembly according to claim 9, further comprising:
a lens which surrounds an outer surface of the laser diode; and
a heat sinking member which surrounds the driving circuit board,
wherein the heat sinking member is inserted into an accommodation space in the first housing, the first and second housings are provided with screw threads at a connection portion therebetween, and a sealing layer is coated on an underside of the driving circuit board.

11. The medical therapy sheet according to claim 6, wherein either the first housing or the second housing is made of heat conductive material.

12. The medical therapy sheet according to claim 6, wherein the second housing is made of metal having a negative potential, and the metal is one of aluminum, aluminum alloy, silver, silver alloy, copper, and copper alloy.

13. The medical therapy sheet according to claim 6, wherein the laser diode generates laser beams having a wavelength in a range from 600 to 890 nm.

14. A laser diode assembly, comprising:
a laser diode having a light source which generates laser beams, and
a penetration hole which allows the laser beams from the light source to pass therethrough and to exit outside thereof;
a printed circuit substrate connected with the laser diode;
a heat sinking member which is made of heat conductive material and which surrounds the printed circuit board; and
a lens installed to surround the penetration hole of the laser diode.

15. The laser diode assembly according to claim 14, wherein the heat sinking member is made of one or more materials selected from a group consisting of aluminum, aluminum alloy, copper, copper alloy, silver, and silver alloy.

16. The laser diode assembly according to claim 14, wherein a sealing material is provided between a contact portion between the printed circuit board and the laser diode.

17. The laser diode assembly according to claim 14, wherein the laser diode and the heat sinking member have a coupling protrusion and a coupling groove at a contact portion thereof to correspond to each other.
